(19) United States
(12) Patent Application Publication
(10) Pub. No.: US 2007/0279918 A1
(43) Pub. Date: Dec. 6, 2007

(54) Lighted and carved carrying container or handbag

(76) Inventor: Joyce Francis, New York, NY (US)

Correspondence Address: BRADLEY N. RUBEN, PC, 463 FIRST ST, SUITE 5A, HOBOKEN, NJ, 07030, US

(21) Appl. No.: 11/443,536

(22) Filed: May 30, 2006

(51) Int. Cl. F21V 1/06

(52) U.S. Cl. 362/352; 362/154

(57) ABSTRACT

An illuminated carried container, such as a handbag, has a light-transmitting body wall with carving on the interior portions, and a light source directed into the thickness of the body, whereby the carving is illuminated when the light source is energized.

### BACKGROUND OF THE INVENTION

This invention pertains especially to handbags with a translucent and/or transparent wall that is illuminated internally within the wall.

Handbags, and bags in general, are typically made of an opaque material. Especially for articles such as handbags, where personal items are kept, opacity of construction is a significant factor, not only because the untidiness of the contents may be unattractive, but also because of safety concerns if valuables are visible within the handbag.

Handbags, or other containers having a handle or strap for carrying or display, have been made with lights for internal illumination of the bag for the user (or wearer) to more easily identify the contents. The bag is typically made of a flexible material, so finding items within can be made more difficult without illumination. Larger, flatter lamps have been used for interior illumination, as described in U.S. Pat. No. 5,067,063. There are also decorative handbags that are transparent or translucent having an internal illumination.

In the early part of the 20^{th} Century poly(methyl methacrylate) (MMA) was invented (and sold now under the well-known LUCITE™). Artisans would take a small sheet of MMA, cut it into a desired geometry, carve one side, and support the sheet in a stand illuminated from the bottom. MMA has also been used since the 1950s in handbags where one of the walls or top is carved.

### SUMMARY OF THE INVENTION

This invention provides a decorative container, such as a handbag, with a rigid transparent wall having a carving and a lamp directing light into the wall thickness to illuminate the carving. The combination of carving in the wall and using the wall as a waveguide, with light directed into the thickness of the wall, provides a unique and aesthetically appealing visual appearance.

In summary, the illuminated container for carrying comprises a solid light-transmitting body defining two openings, one opening being sealed and the other opening fitted with an closable access device, a carrying means, such as a handle or strap, a power source disposed in the container and electrically connected to an illumination source directing light into the thickness of the body. The body is preferably carved, and most preferably on the inside.

### BRIEF DESCRIPTION OF THE DRAWINGS

FIG. 1 is an exploded view of a handbag embodiment of this invention.

FIG. 2 is a drawing and schematic of the lighting and power source in the embodiment of FIG. 1.

FIG. 3 is a front view of the handbag in FIG. 1.

FIG. 4 is a side view of the handbag in FIG. 1.

FIG. 5 is a simulated cross-section through line 5-5 in FIG. 1.

FIG. 6 is a color photograph of a handbag unilluminated.

FIG. 7 is a color photograph of a handbag illuminated.

FIG. 8 is a perspective of another embodiment.

### DETAILED DESCRIPTION OF SPECIFIC EMBODIMENTS

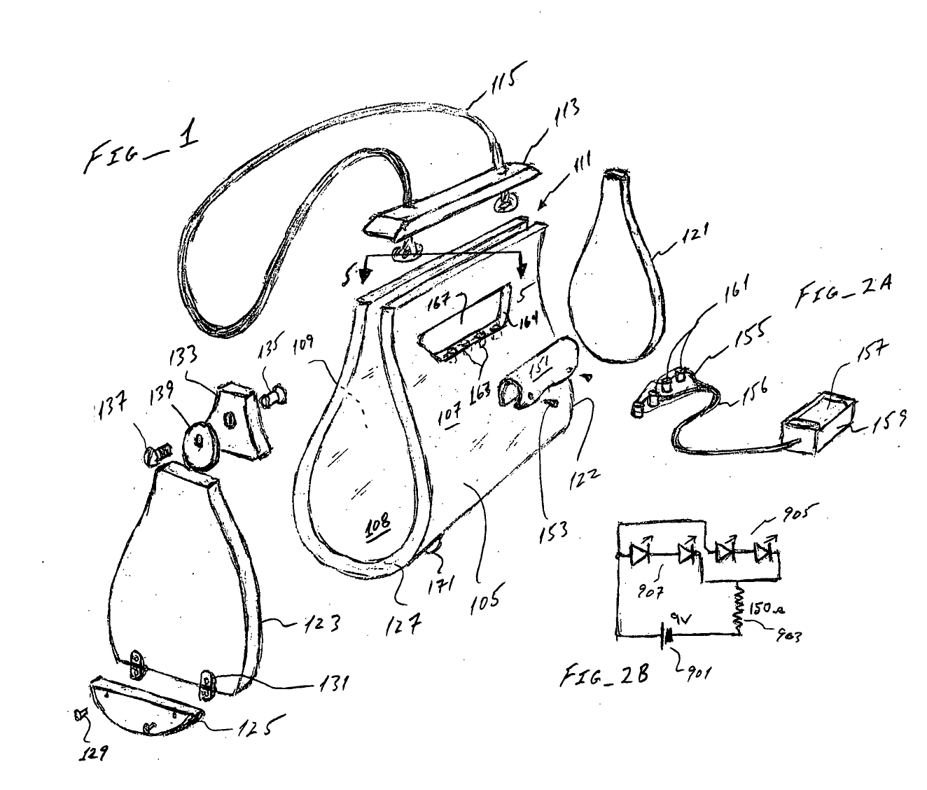

FIG. 1 depicts an exploded view of the a carriable container in the form of a handbag. The body 105 is shown as a single wall formed into a U-shaped body having a back wall 107, a bottom 108, and a front wall 109. The exact geometry is not critical so long as there is an optically continuous piece of material spanning the back and front. The body must be (visible) light-transmitting, and thus transparent and/or translucent. The back and front terminate at an upper portion 111, to which is attached a cover 113 threaded with a carrying device 115 (a strap as shown). A first side 121 covers one side 122 of the body. The opposing side is fitted with an access device, in this embodiment a door 123, a bottom sill 125 and a top support 133. The sill, door, and support cover the opposing side 127 of the body. The door is connected to the sill by any method that allows the door to be secured and opened at will. As shown, the door pivots at the junction with the sill by virtue of hinges 131 connecting the two. The portion of the door adjacent the top support is secured by a simple lock, a rotatable stop 139 held between two fasteners, 135 and 137, passing through bores in the stop and the top support to connect with each other.

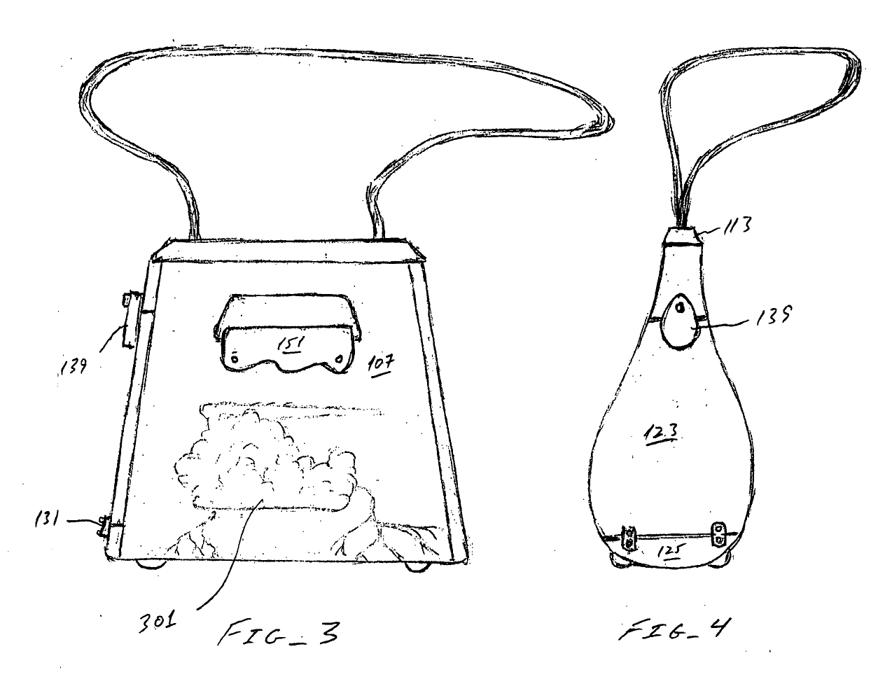

FIG. 2A depicts an illumination source 155 attached via electric connector 156 to a power source, 9V battery 157 disposed in a case 159. The illumination source is preferably an array of individual LEDs 161. Individual LEDs can be used, and there are arrays of LEDs that are commercially available. Commercially available and suitable devices preferably provide at least about 2 candles of illumination. Rectangular panel indicators (available from Fairchild Semiconductor, South Portland, Me.), and bar graph arrays (available from Kingbright, City of Industry, Calif.) provide DIP (dual in-line package type) arrays of LEDs having combined average luminosities of about 2000 mcd to about 9000 mcd or more. FIG. 2B is a schematic showing the battery and four individual LEDs, two pairs 905 and 907 in series, the pair connected in parallel through a resistor (150Ω) back to the battery. Of course, if a DIP type LED array is used, the electrical connector end opposite from the battery will have a socket suitable for accepting such a package.

The illumination source is attached to the body so that the lighting source is directed into the width of the body material. While the illumination source could be placed at the top portion 111, it is preferred to provide a cutout 167 exposing a thickness 164 into which corresponding recesses 163 are provided as receptacles for corresponding lamps, the LEDs 161. A protector 151 is preferred to secure the illumination source; the cover is preferably removably attached with something like screws 153, although other clasps and brackets could be used.

Feet 171 are preferably provided, especially for stability of a body having a curved bottom portion, but could be omitted if the bottom has a flat portion sufficient for the bag to balance.

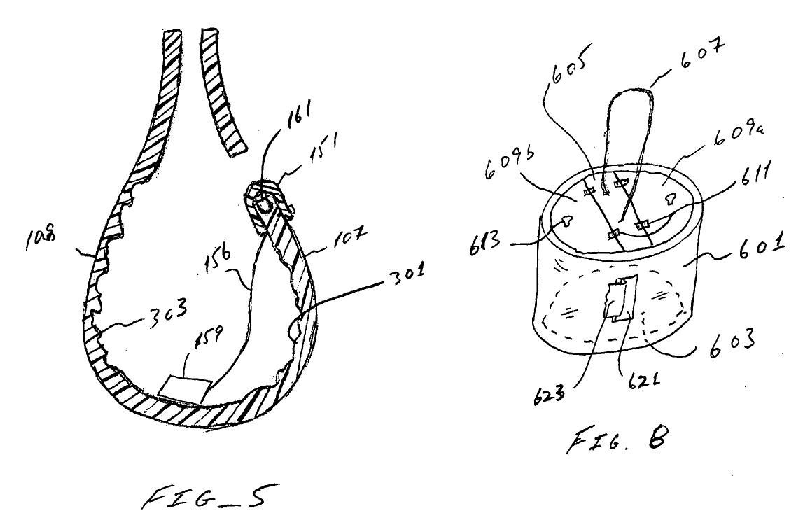

FIG. 3 is a rear view of the handbag showing a carving 301 on the inside of the rear wall. FIG. 4 is a side view of the bag showing the door.

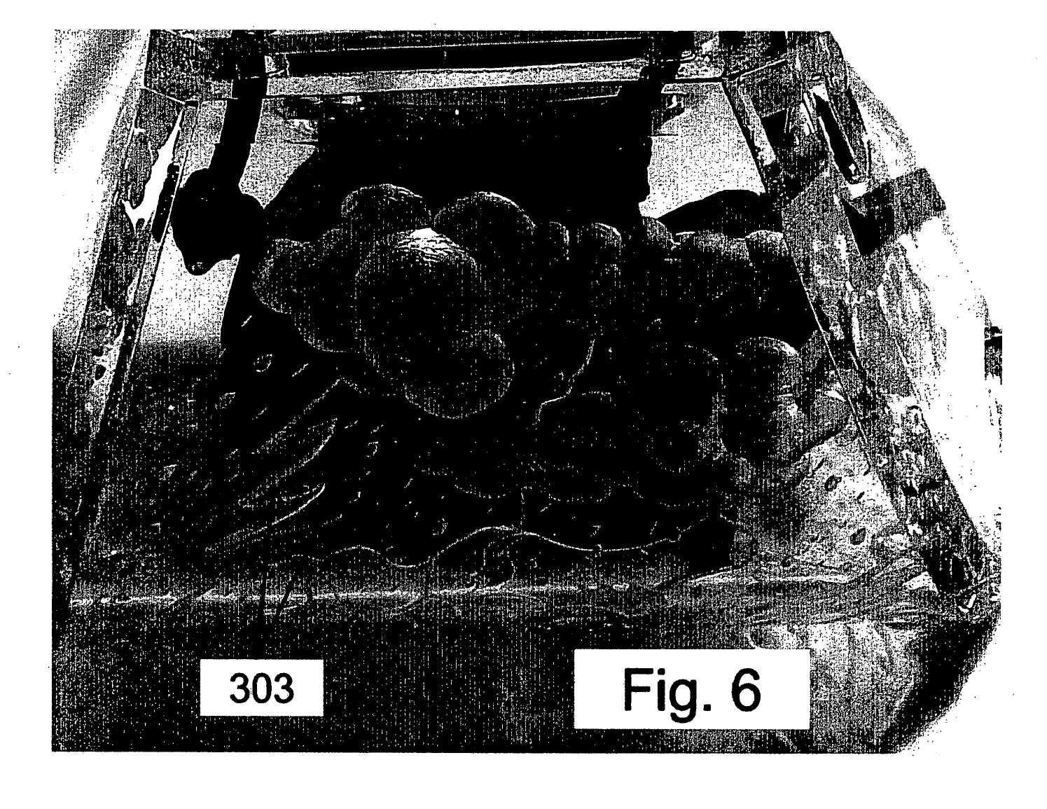

FIG. 5 is a cross section taken via line 5-5 in FIG. 1. The back wall has carving 301 and the front wall has carving 303. As shown, there is optically continuous material connecting the illumination source and the carving on the front wall (as well as the carving on the back, if any).

The body, and preferably the side, door, sill, top portion, cover, stop, and protector are preferably all made of a transparent and/or translucent material, preferably a rigid, self supporting material such as MMA. Of course, any or all of these portions could be made of glass or another ceramic, polycarbonate or another plastic, so long as the material of the body is an optically transparent or translucent material. The light from the illumination source, transmitted into the width or thickness of the body, is transmitted throughout the body, illuminating the carving, and yet the actual source of the light is essentially invisible.

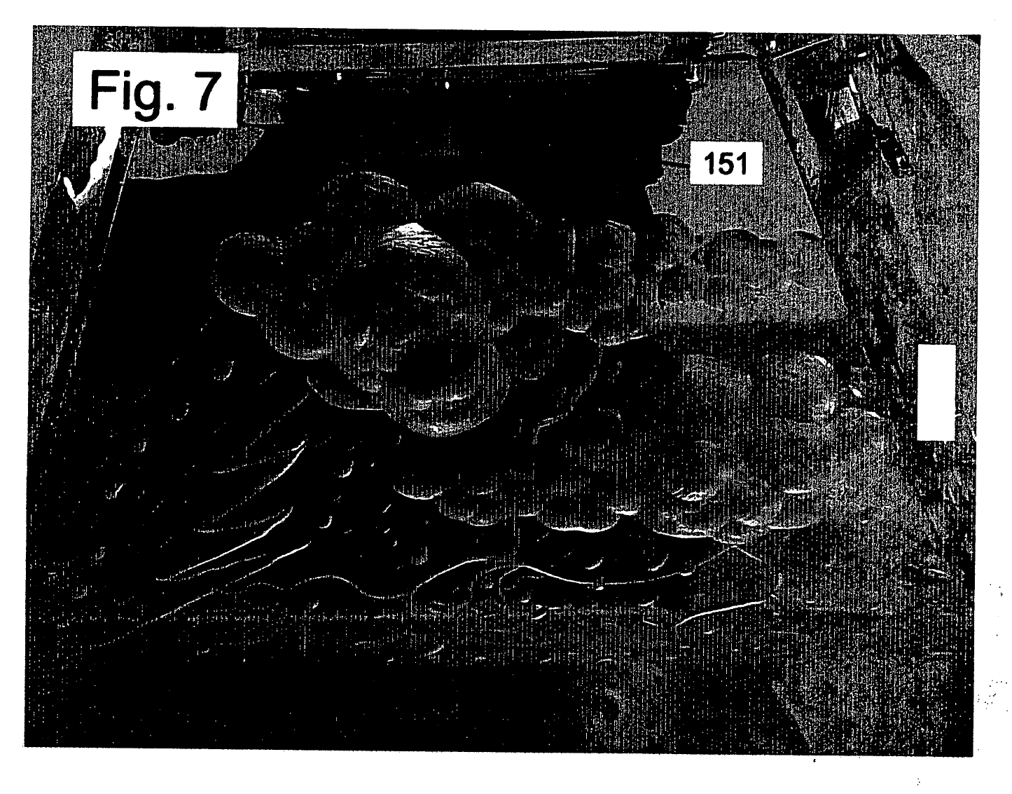

As seen in FIG. 6, a color photograph of an unilluminated bag, all of the bag structure is clear; a black scarf-like material is provided inside the bag to cover the battery and electrical connector, and provide a background for the carving. In FIG. 7, the illumination source is energized and the carving is illuminated, even though there are multiple carvings in the path of the light. That is, taking a straight line from a carving on the front to the illumination source will pass through other carvings. It is preferred that the carving become progressively shallower towards the illumination source for maximum light to pass to the front, but this is not essential. What is essential is that the light source be directed into the body as if the body were a waveguide.

The protector is preferably removable so that LEDs of other colors, or multiple colors, can be replaced by the user.

FIG. 8 depicts another embodiment of a handbag according to this invention. The continuous body 601, preferably including carving (not shown), is in the form of a closed surface, an annulus being shown, although the geometry (viewed end-on) can be ellipsoid or irregular (an irregular closed loop). The body can be cut from a cast tube. A portion of a cast tube can be heated and deformed into an ellipse or an irregular shape. A bottom 603 is provided to seal the bottom opening and frame the bag. Alternatively, a sheet can be curved back on itself and the abutting ends connected with adhesive or hardware. A top portion 603 spanning some opposing sides (chord, diameter) is provided across the top opening. The top portion as shown is provided centrally as an anchor for a carrying aid, in this case a decorative strap or handle 607. Complementary doors 609a/b are shown, each connected to the top portion by hinges 611, and including a knob or pull 613 for easy opening. An opening 621 in the side of the body allows for recesses for LEDs and a cover 623 as shown. Where the body is made by curving a sheet back onto itself, the opening for the LEDs, as in the embodiment shown in FIG. 1, is preferably near the abutting ends. If the body is irregularly shaped, the doors can be custom cut to conform to the desired geometry.

The body and sides, or body, bottom, and top, depending on the embodiment, are preferably connected by a strong adhesive to produce the container per se. Suitable adhesives including cyanoacrylates, epoxies, and, in general, any adhesive sufficiently strong and chemically compatible with the materials of construction. Alternatively, the parts of the container can be attached with screws, chemical rivets, or any means that is aesthetically pleasing and effective to keep the parts together for the intended use. Small items, such as the cover for the LEDs, can be attached by screws, clasps, hasps, or other similar hardware.

Because the illumination is within the body of the container, a backing layer (not shown) can be placed or adhered to the inside of the body, thereby providing a backdrop for the illuminated carving while simultaneously concealing the contents of the container. Of course, a small switch can be provided between the battery and the illumination source to turn the light on and off, or the battery can be removed and replaced as desired.

The foregoing description is meant to be illustrative and not limiting. Various changes, modifications, and additions may become apparent to the skilled artisan upon a perusal of this specification, and such are meant to be within the scope and spirit of the invention as defined by the claims.

1. An illuminated container for carrying, comprising: a rigid, self-supporting, carveable light-transmitting body defining an open volume for storing articles to be carried and spanning first and second openings; the first opening being sealed with a first rigid, self-supporting member and the second opening sealed with a rigid, self-supporting closable second member; a carrying means; and a power source disposed in the container and electrically connected to an illumination source directing light into the thickness of the body.

2. The container of claim 1, wherein the body is U-shaped.

3. The container of claim 2, wherein the second member comprises a sill, a door hingeably attached to the sill, and a top portion including means for selectively securing the door in a closed position.

4. The container of claim 1, further comprising carving in the body effective to be illuminated by light traveling through the thickness of the body.

5. The container of claim 4, wherein the carving is disposed inside the container.

6. The container of claim 1, wherein the end-on geometry of the body is circular, ellipsoid, or an irregular closed loop.

7. The container of claim 1, wherein the power source comprises a battery.

8. The container of claim 1, wherein the illumination source comprises at least one LED.

9. The container of claim 8, wherein the LED is colored.

10. The container of claim 1, wherein the container is illuminated.

11. The container of claim 10, further comprising a liner for the body disposed on the inside of the container adjacent the body.

12. The container of claim 1, wherein the body is an acrylic polymer or a polycarbonate.

13. (canceled)

14. The container of claim 13, wherein the carrying aid is a flexible or rigid handle.

15. An illuminated container for carrying, comprising: a solid light-transmitting body defining first and second openings; the first opening being sealed with a first member and the second opening sealed with a closable second member; a carrying means; and a power source disposed in the container and electrically connected to an illumination source directing light into the thickness of the body; wherein the body is U-shaped and the second member comprises a sill, a door hingeably attached to the sill, and a top portion including means for selectively securing the door in a closed position.

16. The container of claim 15, further comprising carving on the body.

17. The container of claim 16, wherein the carving is disposed inside the container.

18. The container of claim 15, wherein the end-on geometry of the body is circular, ellipsoid, or an irregular closed loop.

19. The container of claim 15, wherein the power source comprises a battery.

20. The container of claim 15, wherein the illumination source comprises at least one LED.
